(19) United States
(12) Patent Application Publication
(10) Pub. No.: US 2005/0025367 A1
(43) Pub. Date: Feb. 3, 2005

(54) Computerized processing method for image data presentation at a display device

(76) Inventor: Thomas Jodoin, Schwabach (DE)

Correspondence Address: SCHIFF HARDIN LLP;Patent Department, 6600 Sears Tower, 233 South Wacker Drive, Chicago, IL, 60606, US

(21) Appl. No.: 10/883,333

(22) Filed: Jun. 30, 2004

(30) Foreign Application Priority Data
Jun. 30, 2003 (DE) 103 29 372.8

(51) Int. Cl. G06K 9/36

(52) U.S. Cl. 382/233

(57) ABSTRACT

In a computerized processing method for an image that can be output to a viewer via a display device, an image file is supplied to a computer from which the computer determines intermediate blocks and a corresponding pixel block for each intermediate block. The pixel blocks in their entirety represent an image that can be output to a viewer via a display device. At least one of the pixel blocks is modified. The computer determines a correspondingly modified intermediate block for each modified pixel block. The remaining intermediate blocks are kept unchanged. Using the entirety of the modified and the unmodified intermediate blocks, the computer determines a changed image file and stores it.

### BACKGROUND OF THE INVENTION

1. Field of the Invention

The present invention concerns a computerized processing method for an image that can be output to a viewer via a display device, of the type wherein an image file is supplied to a computer, wherein a number of intermediate blocks are determined by the computer using the image file, wherein a corresponding pixel block is determined by the computer for each of the intermediate blocks, wherein the pixel blocks in their entirety representing the image, and wherein at least one of the pixel blocks is changed, and wherein a corresponding changed intermediate block is determined by the computer for each changed pixel block, and wherein a changed image file is determined and stored by the computer.

2. Description of the Prior Art

A processing method of the above type known from the Internet page http://www.faqs.org/faqs/jpeg-faq/part1/.

Digital images in the JPEG format enjoy large popularity, in particular in Internet applications, due to their relatively low file size. In the typically marketed digital cameras, the JPEG format also is a widespread storage format for storage on a computer.

The low storage requirement of the JPEG images with simultaneous relatively high image quality is based on the JPEG-specific compression method. This compression method, however, does not operate reversibly or without loss. The deviations from the original image depend on the degree of compression. As a consequence of the technique, even given a compression degree of zero (thus the highest possible quality), an image degradation cannot be completely prevented as a result of quantization errors. In a work cycle that includes the loading of a JPEG image, possibly an alteration of the image, and the subsequent storage of the image in the JPEG format, quality losses therefore always arise.

Lossless processing methods for JPEG images are known. In these processing methods, however, only a few, very specific processing procedures are possible, such as, for example, rotation of the image by whole-number multiples of 90° or mirroring of the image. Generalized processing is not possible with these known processing methods.

### SUMMARY OF THE INVENTION

An object of the present invention is to provide a computerized processing method for an image that can be output to a viewer via a display device, in which any processing procedures are possible and nevertheless the quality losses are kept low.

The above object in accordance with the invention by a processing method of the type initially described wherein, for every modified pixel block, a correspondingly modified intermediate block is determined by the computer, but the remaining intermediate blocks are kept unchanged by the computer, and the changed image file is determined by the computer using the entirety of the modified intermediate blocks and the unmodified intermediate blocks.

The above object also is achieved in accordance with the invention by a computer program stored on a data medium to implement such a processing method. The above object also is achieved by a computer that is programmed for executing the above-described processing method.

In a first embodiment of the present invention, in the determination of the pixel blocks, for each of the intermediate blocks a corresponding post-block (subsequent block) is first determined by the computer, and then the corresponding pixel block is determined using the post-block. In this case, in the determination of the changed image file, a correspondingly modified post-block is first determined by the computer for each modified pixel block, and the correspondingly modified intermediate block is then determined using the modified post-block. In this procedure, the quality losses can be kept particularly low.

In a second embodiment of the present invention, in the determination of the intermediate blocks, using the image file a corresponding pre-block (preceding block) is determined by the computer for each intermediate block, and using the pre-block the appertaining intermediate block is then determined. In this case, in the determination of the altered image file, a correspondingly modified pre-block is first determined for each intermediate block, independent of whether it is a modified or an unmodified intermediate block, and the changed image file is then determined using the entirety of the modified pre-blocks. In his procedure, larger errors can ensue than in the first embodiment, but the method can be managed more flexibly.

The conversion between the intermediate blocks on the one hand and the pre-blocks or post-blocks preferably ensues using a conversion table that is valid for all intermediate blocks. The conversion table is maintained in both conversion directions. It is normally a component of the image file.

To determine the intermediate blocks from the image file, the computer preferably implements a Huffman decoding. This decoding can be reversed without loss.

To determine the pixel blocks from the intermediate blocks, the computer preferably implements an inverse discrete cosine transformation. This transformation, however, cannot be inverted without loss. A higher degree of compression therefore can be achieved with it.

In an embodiment wherein the intermediate blocks and the pixel blocks are rectangular blocks with a block width and a block height, and both the block width and the block height are powers of two, the method can be executed particularly efficiently in terms of calculation. The block width and the block height normally are eight or sixteen.

A common application of the present invention is in the case of the image file being a JPEG file.

### DESCRIPTION OF THE DRAWINGS

FIG. 1 schematically illustrates an overview of a computer system for implementing the inventive method.

FIG. 2 is a flow chart of the basic steps of the inventive method.

FIGS. 3 and 4 schematically illustrate details of the step S2 in the flowchart of FIG. 2.

FIGS. 5 and 6 illustrate details of the step S10 in the flowchart of FIG. 2.

### DESCRIPTION OF THE PREFERRED EMBODIMENTS

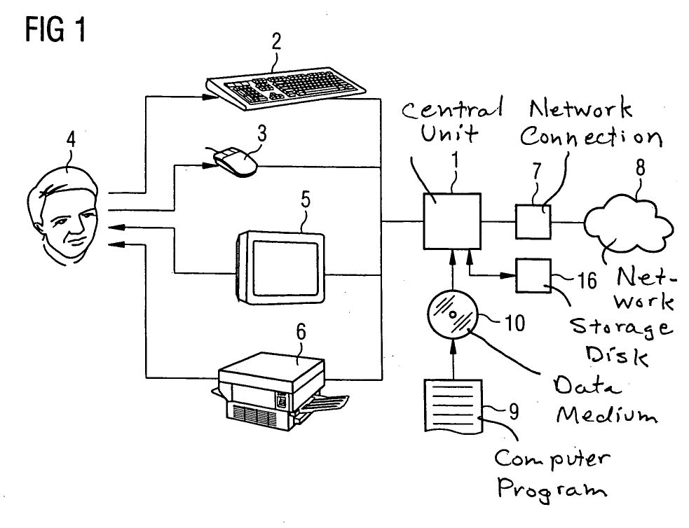

As shown in FIG. 1, a computer has a central unit 1 connected with input devices, for example a keyboard 2 and a mouse 3. By means of the input devices 2, 3, a viewer is able to provide inputs to the computer. The central unit 1 is also connected with output devices, for example a display device 5 and a printer 6. By means of the output devices 5, 6, the computer is able to provide outputs to the viewer 4. The central unit 1 also can be connected via a network connection 7 with a computer network 8, for example the Internet.

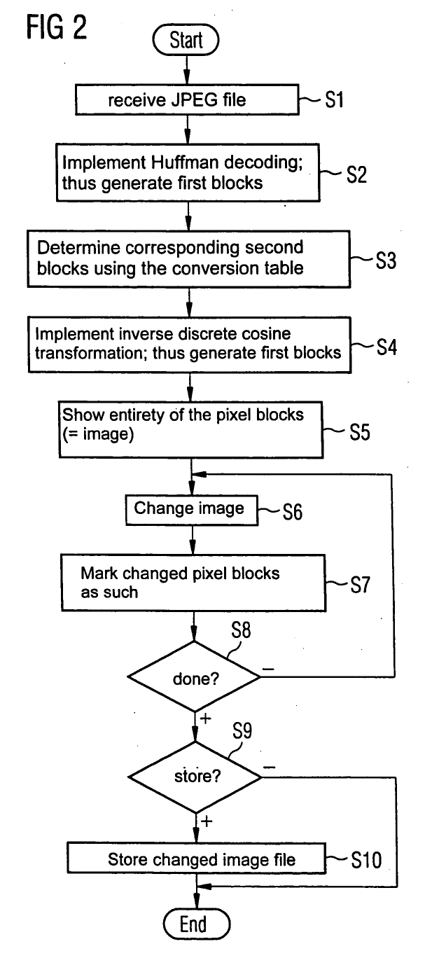

The computer is programmed with a computer program 9 that is supplied to the computer via a data medium 10. Examples of such a data medium 10 are a diskette or CD-ROM. The computer program 9 is stored on the data medium 10 in (exclusively) machine-readable format. Based on the programming with the computer program 9, the computer executes a processing method (subsequently specified in detail in connection with FIG. 2) for an image.

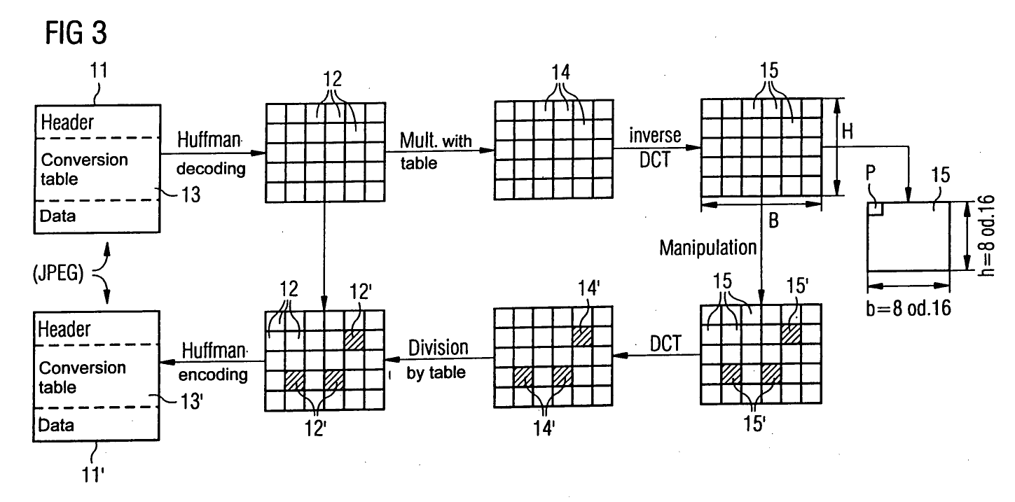

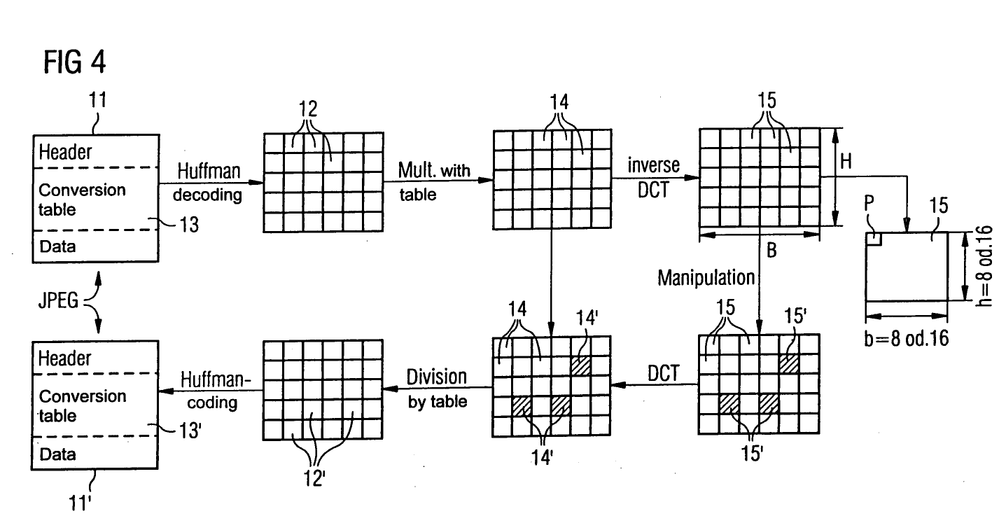

According to FIG. 2—supplemented by FIGS. 3 and 4—the computer is supplied with an image file 11, for example via the computer network 8. The image file 11 is read into a working storage by the computer in a step S1. According to FIGS. 3 and 4, the image file 11 is a JPEG file. In principle, however, the image file 11 could have a different data format.

In a step S2, the computer first implements a Huffman decoding of the image file 11. It thereby generates—see FIGS. 3 and 4—first blocks 12.

In addition to the actual image data, the image file 11 contains a header that, among other things, establishes a total width B and a total height H of the image to be shown. It also comprises a conversion table 13. By consulting this conversion table 13, in a step S3 the computer determines a corresponding second block 14 for each first block 12. The conversion table 13 contains quantization factors that are valid for all first blocks 12. For each of the second blocks 14, in a step S4, the computer then determines pixel blocks 15 by implementing an inverse cosine transformation.

According to FIGS. 3 and 4, each pixel block 15 has a block width b and a block height h. The pixel blocks 15 therefore are rectangular blocks. The block width b is preferably a power of two, for example eight or sixteen. The same is true for the block height h. The block width b and the block height h alternatively can have the same values or values different from one another. Each pixel block 15 preferably is composed of 8×8, 8×16, 16×8 or 16×16 pixels P. Each pixel P thereby exhibits a pixel depth of, for example, eight bits.

As stated above, each pixel block 15 corresponds with precisely one second block 14 and precisely one first block 12. The statements above thus are true not only for the pixel blocks 15, but also for the first blocks 12 and the second blocks 14.

In totality, the pixel blocks 15 form the image to be shown. This image, for example, can be output to the viewer 4 via the display device 5 in a step S5.

In a step S6, it is possible to change the image, and therewith at least one of the pixel blocks 15, in a known manner by the entry of suitable modification commands via the input devices 2, 3. In a step S7, it is noted in accordance with the invention which of the pixel blocks 15 has been changed in step S6, henceforth designated as changed pixel blocks 15′.

In step S8, the computer checks whether a termination command has been provided to it by the viewer 4. If this is the case, it branches to a step S9, otherwise it jumps back to step S6.

In step S9, the computer checks whether a storage command to store the changed image has been provided by the viewer 4. If this is the case, in a step S10 it generates a changed image file 11′ corresponding to the changed image and stores it, for example on a fixed disc 16. Otherwise, it ends the computer program 9 without generating and storing such a changed image file 11′.

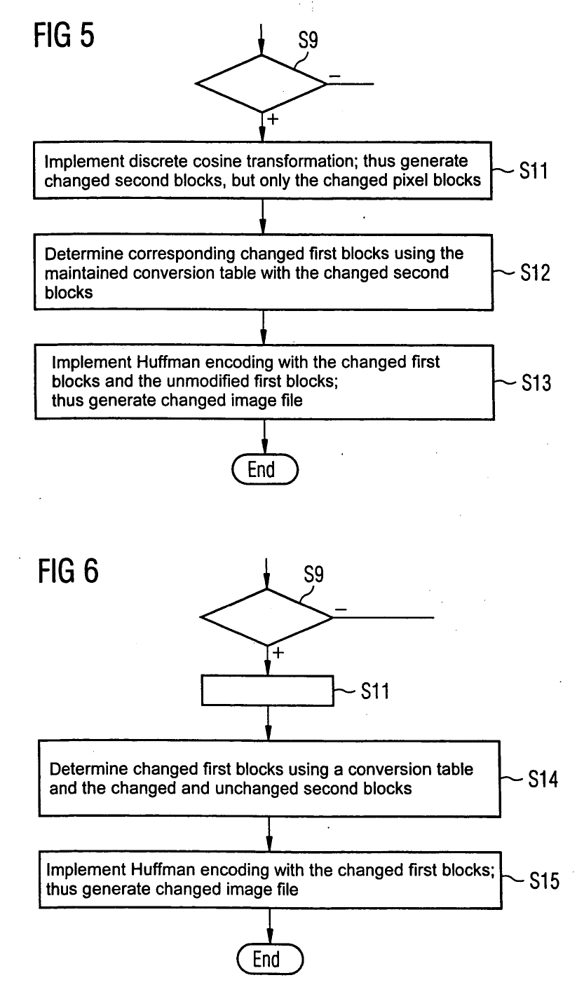

Insofar as the processing method has been previously described in connection with FIG. 2, it corresponds to the known processing methods with the exception of step S7. The invention is based on the inclusion of step S7 and the embodiment of step S10, which is subsequently explained in detail in connection with FIGS. 5 and 6.

According to FIG. 5, the step S10 is divided into three steps S11 through S13. In step S11—see also FIG. 3—a discrete cosine transformation is implemented. The discrete cosine transformation, however, is implemented only for the modified pixel blocks 15′. Thus in step S11 a correspondingly modified second block 14′ is determined only for the modified pixel blocks 15′. In step S12, the correspondingly modified first blocks 12′ are then determined using the—unchanged—conversion table 13. The determination of the modified first blocks 12′ thus ensues only with regard to the modified second blocks 14′ determined in step S11. Using the entirety of the modified first blocks 12′ and the unmodified first blocks 12, in step S13 the computer then determines the changed image file 11′ by the implementation of a Huffman encoding and stores it, for example, on a disc 16.

In the embodiment of the present invention specified in connection with FIG. 5, the first blocks 12, 12′ thus correspond with the intermediate blocks. The second blocks 14, 14′ are post-blocks that correspond with an intermediate representation that is assumed between the intermediate blocks 12, 12′ and the pixel blocks 15, 15′.

In contrast to this, in the embodiment that is subsequently specified in connection with FIG. 6, the intermediate blocks corresponding to the second blocks 14, 14′. The first blocks 12, 12′ corresponding to an intermediate state that is assumed between the image files 11, 11′ and the intermediate blocks 14, 14′.

In the embodiment according to FIG. 6, the step S11 is retained. In contrast to this, the steps S12 and S13 are replaced by steps S14 and S15.

In step S14, all second blocks 14, 14′ (thus both the modified second blocks 14′ and the unmodified second blocks 14) are converted into correspondingly modified first blocks 12′ using a conversion table 13′. The conversion table 13′ can thereby be identical with the conversion table 13, or the conversion table 13′ can contain different values from the conversion table 13.

In step S15, analogous to step S13, the computer executes a Huffman encoding of all modified first blocks 12′ and thus determines the changed image file 11′. In this case, in step S15 a storage of the changed image file 11′ also naturally ensues, for example on the disc 16.

Independently of which of the two embodiments specified in connection with FIGS. 5 and 6 is employed, using the image file 11 the computer thus determines a number of intermediate blocks, namely either the first blocks 12 or the second blocks 14. For each of the intermediate blocks 12, 14, the computer determines a corresponding pixel block 15. For each modified pixel block 15′, the computer also determines a correspondingly modified intermediate block 12′, 14′, while the remaining intermediate blocks 12, 14 remain unchanged. Using the entirety of the modified and the unmodified intermediate blocks 12, 12′, 14, 14′, the computer then determines the changed image file 11′ and stores it.

The procedure described above is that which is used for black-and-white files. With color files, an analogous application is possible for the three color components red, green and blue. Alternatively, luminance and chrominance also can be processed in this manner.

The present invention thus operates to create the changed image file 11′, by accessing the original data insofar as possible (thus the unchanged intermediate blocks 12, 14) and, as necessary, the conversion table 13 is maintained. The quality losses are thereby limited to an unavoidable minimum.

By means of the inventive processing method, quality losses can be kept lower in the processing of images than was previously possible in the prior art. In particular given the procedure specified in connection with FIG. 5, quality losses on the unchanged pixel blocks 15′ can be limited. The unchanged pixel blocks 15 remain without quality loss.

The inventive processing method offers particularly significant advantages when only small regions of the image are changed. A typical application example is the retroactive retouching of the red-eye effect that occurs in flash exposures of people. In contrast, when larger regions of the image are processed, the advantages of the inventive method are reduced, but even then the inventive processing method functions just as well as the processing methods of the prior art.

The image is normally interactively modifiable by the viewer 4, but in principle it is also possible for the computer to automatically determine pixels P to be changed and the new values of the pixels P using predetermined decision criteria. In this case, the processing method can proceed completely automatically, without user input.

Although modifications and changes may be suggested by those skilled in the art, it is the intention of the inventor to embody within the patent warranted hereon all changes and modifications as reasonably and properly come within the scope of his contribution to the art.

1. A computerized processing method for image data for presentation at a display device, comprising the steps of:
supplying an image file, containing image data comprised of pixels, to a computer;
in said computer, determining a plurality of intermediate blocks using said image file;
in said computer, determining a corresponding pixel block for each of said intermediate blocks, a totality of said pixel blocks representing an image of said image file;
allowing at least one of said pixel blocks to be changed;
in said computer, determining a changed intermediate block corresponding to each changed pixel block, while maintaining a remainder of said intermediate blocks unchanged; and
generating and storing a changed image file in said computer comprising each changed pixel block and said remainder of unchanged pixel blocks.

2. A method as claimed in claim 1 wherein the step of determining said pixel blocks comprises, for each intermediate block, first determining a corresponding post-block in said computer, and determining the corresponding pixel block using said post-block, and wherein the step of generating said changed image file comprises, for each changed pixel block, first determining a changed post-block and determining the corresponding changed intermediate block using said changed post-block.

3. A method as claimed in claim 2 comprising determining each post-block in said computer using a conversion table applicable for all of said intermediate blocks, and determining said changed intermediate blocks in said computer also using said conversion table.

4. A method as claimed in claim 3 comprising supplying said conversion table to said computer as a component of said image file.

5. A method as claimed in claim 1 wherein the step of determining said pixel blocks comprises, for each intermediate block, first determining a corresponding pre-block in said computer, and determining the corresponding pixel block using said pre-block, and wherein the step of generating said changed image file comprises, for each changed pixel block, first determining a changed pre-block and determining the corresponding changed intermediate block using said changed pre-block.

6. A method as claimed in claim 5 comprising determining each pre-block in said computer using a conversion table applicable for all of said intermediate blocks, and determining said changed intermediate blocks in said computer also using said conversion table.

7. A method as claimed in claim 5 comprising supplying said conversion table to said computer as a component of said image file.

8. A method as claimed in claim 1 wherein the step of determining said intermediate blocks comprises, in said computer, implementing a Huffman decoding from said image file.

9. A method as claimed in claim 1 wherein the step of determining said pixel blocks from said intermediate blocks comprises, in said computer, implementing an inverse discrete cosine transformation of said intermediate blocks.

10. A method as claimed in claim 1 comprising determining said intermediate blocks and said pixel blocks as rectangular blocks each having a block width and a block height, with each of said block width and said block height being a power of two.

11. A method as claimed in claim 10 wherein each of said block width and said block height is eight.

12. A method as claimed in claim 10 wherein each of said block width and said block height is sixteen.

13. A method as claimed in claim 1 wherein the step of supplying said image file to said computer comprises supplying said image file as a JPEG file to said computer.

14. A computer program stored on a recording medium loadable into a computer that is supplied with an image file containing image data comprised of pixels, for causing said computer to:
determine a plurality of intermediate blocks using said image file;
determine a corresponding pixel block for each of said intermediate blocks, a totality of said pixel blocks representing an image of said image file;
allow at least one of said pixel blocks to be changed;
determine a changed intermediate block corresponding to each changed pixel block, while maintaining a remainder of said intermediate blocks unchanged; and
generate and store a changed image file in said computer comprising each changed pixel block and said remainder of unchanged pixel blocks.

15. A computer supplied with an image file containing image data comprised of pixels, said computer being programmed to operate on said image data for presenting an image represented by said pixels at a display device, by:
determining a plurality of intermediate blocks using said image file;
determining a corresponding pixel block for each of said intermediate blocks, a totality of said pixel blocks representing an image of said image file;
allowing at least one of said pixel blocks to be changed;
determining a changed intermediate block corresponding to each changed pixel block, while maintaining a remainder of said intermediate blocks unchanged; and
generating and storing a changed image file in said computer comprising each changed pixel block and said remainder of unchanged pixel blocks.
